(19) United States
(12) Patent Application Publication
(10) Pub. No.: US 2026/0248102 A1
(43) Pub. Date: Aug. 27, 2026

(54) COLLECTIVE DRINKING DEVICE FOR ANIMALS

(71) Applicant: LA BUVETTE, Tournes (FR)

(72) Inventor: Jean Philippe BOUSQUET, Belval-sous-Châtillon (FR)

(73) Assignee: LA BUVETTE, Tournes (FR)

(21) Appl. No.: 19/165,640

(22) PCT Filed: Mar. 14, 2024
(86) PCT No.: PCT/EP2024/056848

§ 371 Date: Sep. 16, 2025

(30) Foreign Application Priority Data
Mar. 16, 2023 (FR) 2302459

(51) Int. Cl. A01K 7/04

(52) U.S. Cl. CPC A01K 7/04

(57) ABSTRACT

A collective drinking device (1) for animals such as cattle, horses or the like, the device including a drinking trough (2) defining a container (3) and including automatic water supply. The container (3) is defined by at least one series (S1; S2) of at least two drinking bowls (B1, B2) of which a first drinking bowl (B1) is connected to the automatic water supply and of which a second drinking bowl (B2) is connected to the first drinking bowl (B1) via an intercommunication channel (8) open at an upper face (13) of the drinking trough (2).

### FIELD

The present invention relates to a collective drinking device for animals, such as cattle, horses or the like, including a drinker body connected to automatic water supply means.

The present invention relates to the field of collective drinking devices for animals, intended to be installed in livestock buildings, more particularly in which these animals, notably cattle, are in open housing.

### BACKGROUND

Different drinkers for animals are available depending on the environment in which they live. Thus, individual drinking devices are known, often in the form of drinking bowls, installed, for example, in individual boxes or stalls. Such drinking devices are individually connected to water supply means. They may be equipped with a float valve to maintain a constant water level in the drinking bowl or a valve with a control lever operated by the animal. In short, in the latter case, the animal controls the opening of the valve by pressing its snout on the control lever.

Collective drinking devices are known notably from document WO2009/034239 A1. While the drinkers installed in grazing areas are often in the form of large circular or semi-circular troughs, collective drinking devices installed in or near livestock buildings usually include a trough of generally rectangular and elongated shape, on account of which they are commonly referred to as canal drinkers. Document WO2009/034239 A1 describes embodiments including several troughs connected in a row one after the other. More precisely, a trough includes lateral end walls that have communication holes that enable such connection between two troughs arranged in line with each other using connecting means, in this case a flexible connecting end piece and collars.

Although the trough can be made of synthetic material, for example by rotational molding, it is most frequently made of folded and welded stainless steel sheet, which is naturally gnaw-proof. Specifically, this trough includes a bottom of a given length, with front and rear longitudinal walls, as well as the end lateral walls extending from the periphery thereof. The bottom may slope slightly toward a drain plug to facilitate water flow and cleaning of the trough.

When animals go to drink, it is common for there to be food, straw or other remains in their mouths or on their snouts, which fall into the drinker. In this regard, it has been observed that more deposits form in collective drinkers than in individual drinkers, thereby requiring a higher cleaning frequency.

The source of this frequent accumulation of deposits in collective drinkers was investigated as part of an initial inventive approach. For example, it has been found that at least a large proportion of the food falling into an individual drinker during a drink tends to be reingested immediately during that drink or gradually during subsequent drinks, and as such these deposits do not tend to stagnate or accumulate.

This phenomenon does not occur as effectively in collective drinkers. Their tank is dimensioned to allow several animals to drink simultaneously. However, it is very common for fewer animals to come to drink at the same time, and moreover they do not all drink at the same rate. As a result, significant food remains that fall back into the drinker during a drink are not immediately reingested, including during subsequent drinks, and gradually form deposits. These cause bacterial developments that not only make the water less appetizing, but can also be harmful to animals.

It is also understandable why it is essential to regularly drain and clean these collective drinkers in the prior art. Such cleaning is not only burdensome for farmers, but also leads to significant overconsumption of water.

Moreover, because of its large size for simultaneous access by several animals, the water capacity tank of these known collective drinkers is greater than is necessary to water these animals. This inevitably results in a significant amount of water being discarded with each cleaning cycle.

One solution to these problems is to replace collective drinkers with series of individual drinkers, which naturally require as many individual connections to the water supply network. At the same time, although the valves in this type of drinker are generally reliable, the cases of malfunction and the risk of leakage associated with these valves are necessarily greater. Consequently, multiplying the number of drinkers and therefore valves multiplies costs, the likelihood of interventions being required, and the maintenance requirements of such individual drinkers.

As part of an inventive approach, a collective drinker has been devised to accommodate several animals simultaneously with just one water supply valve, simultaneously combining the advantages of individual drinkers.

### SUMMARY

Thus, the invention relates to a collective drinking device for animals, such as cattle, horses or the like, including a drinker body comprising an upper face in which a container is defined and comprising automatic water supply means, this collective drinking device being noteworthy in that the container is defined by at least one series of at least two drinking bowls each comprising, on the upper face of the drinker body, an opening dimensioned to allow one animal to drink at a time, a first of these drinking bowls being connected to said automatic water supply means and a second drinking bowl being connected to the first drinking bowl through an intercommunication channel open on the upper face of the drinker body.

According to the invention, a drinking bowl includes a peripheral wall connected by a rounded portion to a bottom, preferably designed to be concave in shape.

Advantageously, the drinker body includes at one end said automatic water supply means, the series of at least two drinking bowls being aligned on a single line or otherwise from this end.

According to the invention, the container is defined by at least two series of at least two drinking bowls connected together in series via intercommunication channels open on the upper face of the drinker body, of which at least a first drinking bowl of each series is connected to said automatic water supply means.

Advantageously, the drinker body includes, in a middle portion, said automatic water supply means, each of the two series of at least two drinking bowls being aligned on a single line on the two sides of these automatic water supply means.

The advantages of the present invention are that the collective drinking device provides access to water simultaneously to several animals, while ensuring that only one animal can drink from a drinking bowl dimensioned specifically for it, thereby preventing excessive deposition.

Moreover, these drinking bowls are connected together via an intercommunication channel in which a flow of water circulates with each drink, which prevents food product debris from stagnating in these channels. Finally, this debris is systematically returned to the bottom of one of the drinking bowls and is therefore largely reingested as the water is drunk, thereby significantly reducing the frequency of drainage and cleaning cycles.

Other aims and advantages of the present invention are set out more clearly in the following description of exemplary embodiments given by way of example and without limitation.

### BRIEF DESCRIPTION OF THE FIGURE(S)

This description can be better understood with reference to the attached drawings in which:

FIG. 1 is a schematic perspective illustration of a collective drinking device according to a first embodiment of the invention;

FIG. 2 illustrates schematically in perspective three other embodiments of this collective drinking device;

FIG. 3 is a schematic representation of a cross-section of a drinking device according to one of the embodiments visible in FIG. 2;

FIG. 4 illustrates an embodiment of the collective drinking device equipped with anti-licking means;

FIG. 5 illustrates the collective drinking device according to an embodiment similar to the embodiment shown in FIG. 4.

### DETAILED DESCRIPTION

As shown in the attached drawing figures, the present invention relates to a collective drinking device 1 for animals.

This collective drinking device 1 includes a drinker body 2 comprising, on an upper face 13, a container 3 connected to automatic water supply means 4.

Advantageously, these automatic water supply means 4 are preferably of the float valve type designed to maintain a constant reference water level in the container 3 of the drinking device 1. In short, when the water level in the container 3 drops below the reference level when one or more animals are drinking, a float 5 acts on a lever 6 to control the opening of a valve 7 connected to a water supply network. Conversely, when the water in the container 3 reaches the predefined reference level, the action of the water on the float 5 closes the valve 7.

According to the invention, the container 3 is defined by at least one series S1 of at least two drinking bowls B1, B2 each comprising, on the upper face 13 of the drinker body 3, an opening O dimensioned to allow one animal to drink at a time.

In short, the cross-section of this opening O of a drinking bowl is adapted as appropriate to the cross-section of the snout of the type of animal for which the collective drinking device 1 is intended.

Thus, this cross-section of the opening O preferably has an inscribed diameter of between 200 millimeters and 350 millimeters, or even 400 millimeters maximum.

Moreover, a first drinking bowl B1 is connected to said automatic water supply means 4, while a second drinking bowl B2 is connected to the first drinking bowl B1 through an intercommunication channel 8 open on the upper face 13 of the drinker body 2.

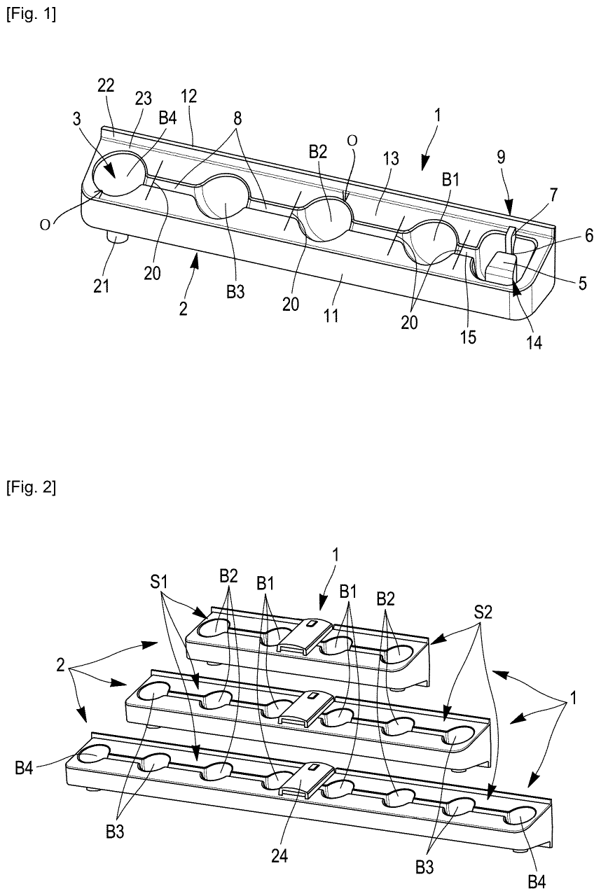

According to a first embodiment shown in FIG. 1, the drinker body 2, which advantageously has an elongate overall shape, includes said automatic water supply means 4 at one end 9, the series S1 of at least two drinking bowls B1, B2, B3, B4, etc. being aligned on a single line X from this end 9. It should be noted in this regard that the invention is not limited to this configuration of aligned drinking bowls B1, B2, B3, B4, which can be arranged differently one behind the other, for example in a circle or eclipse.

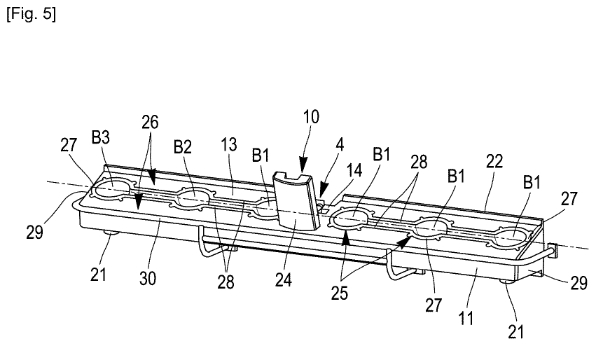

According to other preferred embodiments of the invention, shown in FIGS. 2 to 5, the container 3 is defined by at least two series S1, S2 of at least two drinking bowls B1, B2, B3, etc. connected together in series via intercommunication channels 8 open on the upper face 13 of the drinker body 2, of which at least a first drinking bowl B1 of each series S1, S2 is connected to said automatic water supply means 4.

Advantageously, the drinker body 2, which preferably has an elongate shape, includes, in a middle portion 10, said automatic water supply means 4, each of the two series S1, S2 of at least two drinking bowls B1, B2, B3. B4, etc. being aligned on a single line X or otherwise on the two sides of this middle portion 10 and these automatic water supply means 4.

As already mentioned above, the drinker body 2 has an elongated shape and also preferably has at least one front face 11 and one rear face 12, surmounted by the upper face 13 on which the drinking bowls B1, B2, B3, B4, as applicable, of one or more series S1, S2 are arranged, along with the intercommunication channels 8 connecting the drinking bowls B1, B2, B3, B4 of a series S1, S2 together. These intercommunication channels 8 are therefore open on the upper face 13 of the drinker body 2.

On this upper face 13, a housing 14 in the form of a cavity for receiving the automatic water supply means 4 may also be provided, depending on the case, at one end 9 of the drinker body 2 or in a middle portion 10 of the latter. The first drinking bowl B1 of the one or more series S1, S2 of drinking bowls B1, B2, B3, B4 is connected to this housing 14. This connection may be in the form of a feed duct or may advantageously take the form of an intercommunication channel 15 open on said upper face 13 of the drinker body 2.

With reference again to the shape of the drinking bowls B1, B2, B3, B4 and as already indicated above, they have an opening O on the upper face 13 of the drinker body 3 which is dimensioned to allow one animal to drink at a time.

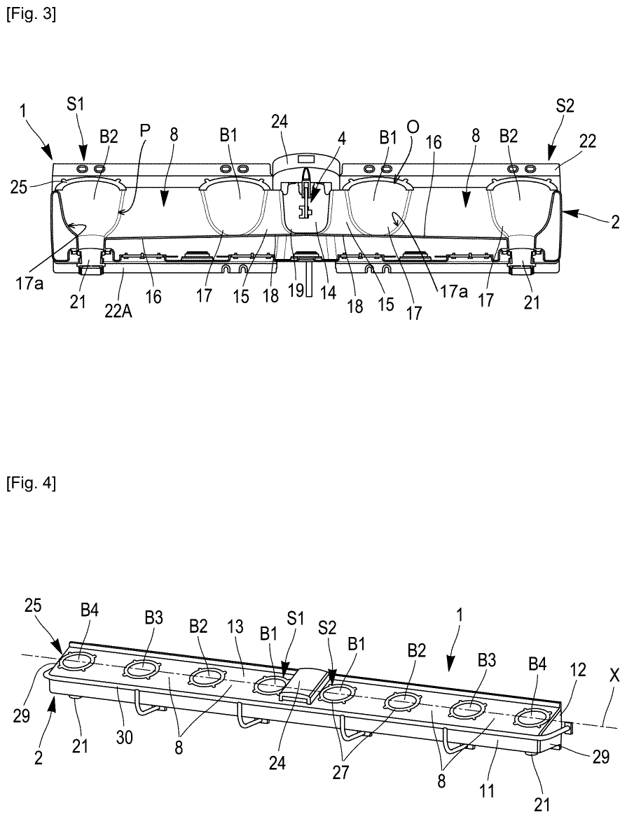

A drinking bowl B1, B2, B3, B4 furthermore includes a peripheral wall P connected to the bottom 17 by a rounded portion 17a as shown in FIG. 3.

In an advantageous embodiment, this rounded portion 17a extends substantially from the peripheral wall P toward the center of the bottom 17, giving the latter a concave, substantially hemispherical or semi-ovoid shape.

According to yet another feature of these drinking bowls B1, B2, B3, B4, the peripheral wall thereof is frustoconical, tapering from the opening O toward the bottom 17.

These drinking bowls B1, B2, B3, B4 are also preferably round or ovoid in cross-section. However, they may be of polygonal cross-section, notably square, while complying with the condition that their opening O on the upper face 13 of the drinker body 3 is dimensioned to allow one animal to drink at a time. Thus, this cross-section, which may be polygonal, preferably has an inscribed diameter of between 200 millimeters and 350 millimeters, or even 400 millimeters maximum.

It should be noted that in such a configuration with bowls of polygonal cross-section, the peripheral wall has sides joined by rounded portions with a radius of at least one centimeter, preferably greater than two centimeters.

As shown in the cross-sectional representation in FIG. 3, the bottom 16 of the intercommunication channels 8 preferably communicates with the bottom 17 of the drinking bowls B1, B2, B3, B4.

Advantageously, the bottom 18 of the intercommunication channel 15 communicates with the bottom 17 of the first drinking bowl B1 of a series S1, S2 and the bottom 19 of the housing 14.

According to an advantageous embodiment:
the bottom of the drinking bowls B1, B2, B3, B4 of a series S1; S2,
the bottom 16 of the intercommunication channels 8 connecting them
and the bottom 18 of the intercommunication channel 15 are on the same horizontal plane, or even form a slight downward slope from the housing 14 toward the farthest drinking bowl B2; B3; B4.

Bearing in mind that the automatic water supply means 4 are used to maintain a constant water level in the container 1 and therefore the drinking bowls B1, B2, B3, B4, the above configuration makes it possible to supply each of these drinking bowls B1, B2, B3, B4 jointly each time the valve 7 is opened.

The fact that the bottoms 16, 17, 18 are on the same level enables a flushing effect between the drinking bowls B1, B2, B3, B4, preventing debris from stagnating, notably in the intercommunication channels 8, 15.

According to the invention, the drinking bowl B2; B3; B4 furthest from said automatic water supply means 4 includes drainage means 21. It should be noted that the flushing effect described above also facilitates the removal of debris during drainage and cleaning operations. By way of example, such drainage means 21 may be defined by a drain plug in the bottom 17 of this drinking bowl B2; B3; B4.

The flushing effect and the draining of the container 3 of the drinking device 1 are enhanced if the bottoms 16, 17, 18 slope slightly downwards from the housing 14 toward the farthest drinking bowl B2; B3; B4.

Preferably, the bottom 16; 18 of an intercommunication channel 8; 15 is designed to be wide enough, for example greater than 0.5 cm, to be reached with at least one finger of one hand to easily push away debris and any deposits in these channels 8, 15 during cleaning operations.

According to an advantageous embodiment, the automatic water supply means 4 and the cross-section 20 of the intercommunication channels 8, 15 are dimensioned to provide each drinking bowl B1, B2, B3, B4 with water at a rate determined in consideration of the rate at which the water is likely to be ingested by several animals drinking simultaneously from each of these drinking bowls B1, B2, B3, B4.

It should be noted that this water flow rate capable of being delivered by the automatic water supply means 4 does not necessarily have to be equal to the maximum water flow rate that can be taken from the container 3 if several animals are drinking simultaneously from each of the drinking bowls B1, B2, B3, B4 in the drinking device 1.

Moreover, the channels 15, 8 may have identical cross-sections 20 or different cross-sections. Thus, the cross-section of the channel 15 connecting the housing 14 and the first drinking bowl B1 of a series S1 may be larger than the cross-section of the channel 8 connecting this first bowl B1 to the following bowl B2, or even than the cross-section of all subsequent channels.

Similarly, the intercommunication channels 8 between the drinking bowls may all be of identical cross-section, or of different cross-sections.

As shown in the various FIGS. 1, 2, 4 and 5, the rear face 12 of the drinker body 2 may define a face for engagement and fastening to a support such as a wall. By way of example, a fastening rim 22 extending this rear face 12 above the upper face 13 and including openings 23 for fastening members, for example screws, is illustrated. The lower edge 22A of this rear face 12 can also define an engagement rim provided with openings for fastening screws or simply inserted into at least one engagement rail previously fastened to the wall.

Obviously, this drinking device is not necessarily intended to be fastened to a vertical support. It can also be positioned on a support structure allowing it to be positioned on the ground anywhere in a livestock farm.

FIGS. 2 to 5 show the housing 14 containing the automatic water supply means 4 closed by a cover 24 preventing access by animals, this cover 24 nonetheless being removable to enable access to these automatic water supply means 4 and to allow maintenance and cleaning operations. In particular, this cover 24 can be pivotingly mounted on the drinker body 2 above the housing 14, and equipped with locking means designed to cooperate with complementary locking means on the drinker body 2. Advantageously, this cover 24 may also have elastic means for automatically returning it to a closed position at each unlocking command.

This housing 14 may be of similar shape to the bowls in that it is circular, ovoid or polygonal in cross-section, its peripheral wall connects the bottom of this housing by rounded portions to prevent debris from stagnating in the corner between this bottom and this peripheral wall. Here again, this rounded portion has a radius greater than one centimeter, preferably greater than two centimeters. This bottom of the housing 14 and the bottom 18 of the intercommunication channel 15 are advantageously in the same horizontal plane, or even form a slight downward slope from the housing 14 toward the first drinking bowl B1.

The drinker body 2 can be made of different materials. Thus, it can be made from cast metal or from sheet metal, notably stainless steel sheet, by stamping and/or mechanical welding. It may also be made of synthetic material, optionally composite material, by injection molding, thermoforming, laminating or rotational molding.

Advantageously, at least the walls of the drinking bowls B2; B3; B4, or intercommunication channels 8 and/or 15 and/or the walls of the housing 14 undergo a surface treatment, for example polishing and/or application of a material with a low surface tension, to prevent or at least limit the debris and other dirt sticking to these walls.

If synthetic material is used, the drinker body 2 is preferably equipped with anti-licking means 25 and/or anti-gnawing means 26.

Said anti-licking means 25 may be provided on the upper face 13 of the drinker body 2 by a metal rim 27 surrounding the drinking bowls B1, B2, B3, B4, extending slightly above these drinking bowls B1, B2, B3, B4.

Different embodiments of the anti-gnawing means 26 may be provided depending on the part of the drinker body 2 to be protected. Thus, metal strips 28 may be used to reinforce the edges of the channels 8, 15. For the same purpose, a protective bar 30 may be arranged in front of the front face 11 or of the lateral sides 29 to prevent the drinker body 2 from being gnawed at the corner between the upper face 13 and said front face 11, or these lateral sides 28. Such a bar 30 essentially protects the drinking device 1 against impacts.

Where the drinking device 1 is installed centrally on a support structure and not against a wall, this protective bar 30 may surround the drinker body 2.

If the drinking device 1 is intended to be fastened against a wall, its upper face 13 advantageously forms a plane with a slight downward incline from the rear face 12 toward the front face 11 to facilitate the sliding discharge of any debris falling on this drinking device between the bowls B1, B2, B3, B4. For the same purpose, in the case of a central installation, this upper face 13 can define two inclined planes descending from a longitudinal median plane.

1-17. (canceled)

18. A collective drinking device for animals, such as cattle, horses or the like, including a drinker body comprising an upper face in which a container is defined and comprising automatic water supply means, characterized in that the container is defined by at least one series of at least two drinking bowls each comprising, on the upper face of the drinker body, an opening dimensioned to allow one animal to drink at a time, a first drinking bowl being connected to said automatic water supply means and a second drinking bowl being connected to the first drinking bowl through an intercommunication channel open on the upper face of the drinker body.

19. The collective drinking device as claimed in claim 18, wherein the opening has a cross-section comprising an inscribed diameter of between 200 millimeters and 400 millimeters, preferably between 200 and 350 millimeters.

20. The collective drinking device as claimed in claim 18, wherein a drinking bowl includes a bottom connected to a peripheral wall by a rounded portion extending from said peripheral wall toward the center of the bottom, giving the latter a concave, substantially hemispherical or semi-ovoid shape.

21. The collective drinking device as claimed in claim 18, wherein the peripheral wall of a drinking bowl is frustoconical, tapering from its opening toward its bottom.

22. The collective drinking device as claimed in claim 18, wherein the drinker body includes at one end said automatic water supply means, the series of at least two drinking bowls being aligned on a single line or otherwise from this end.

23. The collective drinking device as claimed in claim 18, wherein the container is defined by at least two series of at least two drinking bowls connected together in series via an intercommunication channel open on the upper face of the drinker body, of which at least a first drinking bowl of each series connected to said automatic water supply means arranged in a middle portion of the drinker body.

24. The collective drinking device as claimed in claim 18, wherein the drinker body has an elongated shape and has at least one front face and one rear face, surmounted by the upper face on which the drinking bowls of one or more series are arranged, along with the intercommunication channels connecting the drinking bowls of a series together.

25. The collective drinking device as claimed in claim 18, wherein a housing in the form of a cavity is provided on the upper face of the drinker body for receiving the automatic water supply means, the first drinking bowl of the one or more series of drinking bowls being connected to this housing.

26. The collective drinking device as claimed in claim 25, wherein the first drinking bowl of a series is connected to the housing through an intercommunication channel open on said upper face.

27. The collective drinking device as claimed in claim 18, wherein the bottom of the intercommunication channels communicates with the bottom of the drinking bowls.

28. The collective drinking device as claimed in claim 26, wherein the intercommunication channel has a bottom which communicates with the bottom of the first drinking bowl of a series and with the bottom of the housing.

29. The collective drinking device as claimed in claim 27, wherein:
the bottom of the drinking bowls of a series,
the bottom of the intercommunication channels connecting them
and the bottom of the intercommunication channel slope slightly downwards from the housing toward the furthest drinking bowl.

30. The collective drinking device as claimed in claim 18, wherein the drinking bowl furthest from the automatic water supply means includes drainage means.

31. The collective drinking device as claimed in claim 18, wherein the drinker body is equipped with anti-licking means and/or anti-gnawing means.

32. The collective drinking device as claimed in claim 18, wherein the drinker body is made of metal by casting or of sheet metal, notably stainless steel sheet, by stamping and/or mechanical welding.

33. The collective drinking device as claimed in claim 18, wherein the drinker body is made of synthetic material, optionally composite material, by injection molding, thermoforming, laminating or rotational molding.

34. The collective drinking device as claimed in claim 18, wherein at least the walls of the drinking bowls undergo a surface treatment, for example polishing and/or application of a material with a low surface tension.
